(19) United States
(12) Patent Application Publication
(10) Pub. No.: US 2012/0030115 A1
(43) Pub. Date: Feb. 2, 2012

(54) SYSTEMS AND METHODS FOR PREVENTING FRAUDULENT BANKING TRANSACTIONS

(76) Inventors: Deborah Peace, Harrison, TN (US); David Peace, Harrison, TN (US); Alan Lane, Birchwood, TN (US)

(21) Appl. No.: 13/176,157

(22) Filed: Jul. 5, 2011

Related U.S. Application Data
(63) Continuation-in-part of application No. 12/347,847, filed on Dec. 31, 2008, now Pat. No. 7,974,893.
(60) Provisional application No. 61/361,024, filed on Jul. 2, 2010.
(60) Provisional application No. 61/105,588, filed on Oct. 15, 2008.
(60) Provisional application No. 61/019,166, filed on Jan. 4, 2008.

(51) Int. Cl. G06Q 40/00; G06Q 20/00

(52) U.S. Cl. 705/44; 705/64

(57) ABSTRACT

A system and method for protecting account holders against fraudulent transactions by receiving authorization criteria, wherein the authorization criteria relates to one or more characteristics associated with financial transactions that involve an account in a financial institution; receiving incoming transaction data wherein the incoming transaction data is associated with an underlying financial transaction involving the account; identifying the one or more characteristics associated with the incoming transaction relating to the authorization criteria received; identifying prior transactions with one or more characteristics corresponding with the identified one or more characteristics associated with the incoming transaction data; comparing the incoming transaction data with the authorization criteria; suspending the underlying transaction associated with the incoming transaction data if the authorization criteria is not satisfied; transmitting notification of the suspension to the account holder associated with the suspended underlying transaction data through a first communication method, wherein the transmitted notification includes a unique item of information; and permitting the suspended underlying transaction to proceed if the unique item of information is received through a second communication method.

### CROSS REFERENCE TO RELATED APPLICATIONS

This application claims priority to U.S. Provisional Patent Application Ser. No. 61/361,024, filed Jul. 2, 2010, and as a continuation-in-part of U.S. Non-provisional patent application Ser. No. 12/347,847, filed Dec. 31, 2008, which claims priority to U.S. Provisional Patent Application Ser. No. 61/105,588, filed Oct. 15, 2008 and U.S. Provisional Patent Application Ser. No. 61/019,166, filed Jan. 4, 2008. This application is also related to U.S. Non-provisional patent application Ser. No. 13/108,306, filed May 16, 2011, which is a continuation of U.S. Non-provisional patent application Ser. No. 12/347,847. The disclosures of all of these applications are incorporated herein by reference.

### BACKGROUND OF THE INVENTION

1. Field of the Invention

The subject disclosure is directed to systems and methods for facilitating ACH transactions and ACH transaction disputes.

2. Background of the Related Art

The Automated Clearing House (ACH) is an electronic payment network used by individuals, businesses, financial institutions and government organizations to electronically debit or credit funds to an account. Electronic ACH payments are generally preferred over traditional paper checks because they provide better cash management capabilities, are quicker to complete and have lower associated costs.

The ACH network is used to transfer funds throughout the 50 states as well as in U.S. territories and Canada with participation by over 98% of the nation's financial institutions, including thousands of savings banks and credit unions. In addition, efforts are underway for the development of a worldwide ACH Network, known as the Worldwide Automated Transaction Clearing House (WATCH).

ACH transactions are forwarded along with pertinent instructions or information such as the individual or company name, financial institution routing number, account number, amount and effective date for the transaction.

Typically, these transactions begin upon one company or individual (receiver) authorizing another company or individual (originator) to initiate a ACH transaction to their financial institution account. The originator prepares information about the ACH transactions and passes it along to an Originating Depository Financial Institution (ODFI). The ODFI collects and consolidates the information regarding the ACH transactions and presents it to an ACH Operator. The ACH Operator processes the ACH transaction information from submitting ODFIs and distributes it to the appropriate Receiving Depository Financial Institutions (RDFIs). Each RDFI receives entries for its customer accounts and posts entries on the settlement date.

Thus, incoming ACH transactions are picked up by the RDFI and/or their Processor from the ACH Operator and then processed by the core banking system for posting to the appropriate accounts. Account holders (corporate & consumer) typically see that an ACH transaction has occurred or posted to their account by reviewing a periodic account statement. Thus, if the transaction was a debit, the corresponding funds are removed as of the settlement date. It should be readily apparent that an unauthorized or unexpected ACH transaction may deplete the account without warning, possibly resulting in overdrafts, non-sufficient funds (NSF) fees and damaged relationships.

The advent of online and mobile banking provides account holders with the ability to check ACH activity without waiting for periodic statements. However, such notification is essentially equivalent to receipt of an “early” periodic statement, since any ACH transactions shown will have already posted (i.e., the funds will have already been debited). Thus, the account holder is still without immediate recourse in the case of an unauthorized or unexpected ACH transaction.

Financial institutions have the capability to block all ACH transaction activity from posting to an account holder's account. However, account holders are thus precluded from accepting any ACH transactions, including authorized ACH transactions. [0012] In summary, no known prior alternative exists for filtering and suspending ACH transactions, prior to posting, based on rules established by the receiving depository financial institution and/or their account holder. While prior alternatives exist for notification of electronic transactions via email, cell phone text message, voice response systems (VRU), fax and/or pager, none of these alternatives specifically address notification of ACH transactions, after they occur but before they post, or enable the account holder to respond to the notification to provide return instructions and electronically complete the written statement under the penalty of perjury (WSUPP) or otherwise contest the charge if the transaction is unauthorized.

Prior alternatives for allowing participating depository financial institutions to exchange request for authorizations, provide proof of authorizations and written statements under the penalty of perjury have been via phone, fax or mail. The timelines established by National Automated Clearing House Association (NACHA) for exchanging the information between parties make these methods inefficient, unreliable and costly.

Furthermore, according to NACHA, there has been a shift in the online criminal world from primarily targeting of individuals to increased targeting of corporations. Financial institutions of all kinds have all reported a significant increase in funds transfer fraud involving the exploitation of valid online banking credentials belonging to businesses. Criminal groups are believed to be responsible for these activities which often also employ witting and unwitting accomplices to receive, cash and forward payments from thousands to millions of dollars to overseas locations via popular money and wire transfer services.

Corporate accounts are often compromised by an e-mail impersonating a legitimate business which directly names the recipient correctly and contains either an infected file or a link to an infectious Web site. The e-mail recipient is generally a person within a company who can initiate funds transfers or payments on behalf of the business. Once the user opens the attachment, or clicks the link to open the Web site, software generally referred to as “malware” is installed on the user's computer that usually consists of a keystroke logger, which harvests the user's corporate online banking credentials. The stolen credentials may then be used to directly initiate a funds transfer masquerading as a legitimate user. Illegitimate funds transfers are then made, often as ACH transactions, from the corporation bank accounts to the bank accounts of willing or unwitting individuals, who often then send the funds on to the criminal group.

Electronic ACH payments are generally preferred over traditional paper checks for certain types of payments, such as salaries, because they provide better cash management capabilities, are quicker to complete and have lower associated costs.

As discussed above, legitimate ACH transactions begin upon one company or individual (receiver) authorizing another company or individual (originator) to initiate an ACH transaction to their (the receiver's) account at a financial institution. The originator prepares the necessary instructional information about the ACH transactions and forwards the information to an Originating Depository Financial Institution (ODFI). The ODFI collects and consolidates the information regarding the ACH transactions and presents it to an ACH Operator. The ACH Operator processes the ACH transaction information from submitting ODFIs and distributes it to the appropriate Receiving Depository Financial Institutions (RDFls). Each RDFI receives entries for its customer accounts and posts entries on the settlement date.

Thus, incoming ACH transactions are picked up by the RDFI and/or their Processor from the ACH Operator and then processed by the core banking system for posting to the appropriate accounts. Account holders (corporate & consumer) typically see that an ACH transaction has occurred or posted to their account by reviewing a periodic account statement. Thus, if the transaction was a debit, the corresponding funds are removed as of the settlement date.

For example, an employer may utilize the ACH system to effectuate the direct deposit of the employee payroll by submitting the instructional information for the ACH transactions (e.g., the biweekly apportionment of annual salary) to the employer's bank (which would be the ODFI in this example). The employer's bank as ODFI would subsequently present the information regarding the ACH transactions to an ACH operator for further processing and distributing to each of the respective employee's accounts in various banks (the RDFIs).

It should be readily apparent that an unauthorized or unexpected ACH transaction may deplete the account without warning, possibly resulting in overdrafts, non-sufficient funds (NSF) fees and damaged relationships, among other things. For at least the foregoing reasons, there is a compelling need in the art for systems and methods that facilitate secure transactions and fraud prevention.

### SUMMARY OF THE INVENTION

Some embodiments of the invention provide a system and method for identifying incoming ACH transactions involving subscriber accounts at a financial institution, comparing the ACH transaction details with preset notification criteria, suspending any ACH transaction that satisfy the preset criteria so that the transaction does not post to the account, notifying the subscriber of the incoming ACH transaction, providing the subscriber with the option to either authorize or dispute the ACH transaction, and facilitating the dispute process according to applicable banking rules by requesting further information from the subscriber and forwarding the dispute information to the ACH operator.

In some embodiments, the system and method includes a filtering mechanism to strip out and suspend eligible ACH transactions for the purpose of notifying the account holder same day and allowing the account holder to accept or reject the transaction in an automated fashion.

Some embodiments also provide the ability to automatically reject a transaction, provide the reason for the rejection, have the system create the return transaction and obtain and complete an electronic written statement under the penalty of perjury (WSUPP).

Some embodiments further provide for storing the WSUPP, accepting and delivering requests for authorization, proof of authorization and an alert system for automatically notifying the originating depository financial institutions (ODFI) and receiving depository financial institutions (RDFI) when relevant deadlines are approaching.

Some embodiments provide a method of protecting account holders against fraudulent transactions, which includes the steps of receiving an election of notification criteria from an account holder through a data input device, wherein the notification criteria relates to characteristics of financial transactions that involve an account in a financial institution; receiving transaction data through the data input device wherein the transaction data is associated with an underlying transaction involving the account; comparing the transaction data with the notification criteria elected by the account holder; suspending the underlying transaction associated with the transaction data if the notification criteria is satisfied, wherein suspension prevents the transaction from affecting the account; notifying the account holder of the underlying transaction associated with the transaction data; and querying the account holder as to whether the underlying transaction is disputed, wherein further information as required by any applicable rules is requested from the account holder if a dispute of the underlying transaction is indicated by the account holder.

The underlying transaction may be an ACH transaction and the transaction data may include the amount of money involved in the underlying transaction, the parties involved in the underlying transaction and an SEC code associated with the transaction, among other things.

In some embodiments, the aforementioned method further includes the steps of providing a listing of characteristics relating to transactions to the account holder; and receiving an election of listed characteristics from the account holder.

In some embodiments, the aforementioned method further includes the step of storing the elected notification criteria in a database. The notification data may also prescribe the means by which the account holder is to be notified.

In some embodiments, the aforementioned method further includes the step of querying the account holder as to whether the underlying transaction is authorized, wherein the underlying transaction is unsuspended if authorization is received from the account holder.

In some embodiments, the aforementioned method further includes the steps of querying the account holder as to whether transactions of substantially similar characteristics are to be automatically authorized in the future, receiving a response by the account holder, wherein the response includes an election of characteristics, and changing the notification criteria based on the election of characteristics in the response.

In some embodiments, the aforementioned method includes the steps of determining whether an underlying transaction involves an account holder having elected notification criteria, and permitting the transaction to proceed if the transaction involves an account holder without elected notification criteria.

In some embodiments, the aforementioned method further includes the steps of receiving the further information requested from the account holder, formatting the further information received pursuant to any applicable rules, and transmitting the formatted information to the sender of the transaction data.

Some embodiments provide a system of protecting account holders against fraudulent transactions, which includes a data input device configured for receiving an election of notification criteria from an account holder and receiving transaction data through the data input device, among other things; a data processing device configured for comparing the transaction data with the notification criteria elected by the account holder and suspending the underlying transaction associated with the transaction data if the notification criteria is satisfied, among other things; a data output device configured for notifying the account holder of the underlying transaction associated with the transaction data and querying the account holder as to whether the underlying transaction is disputed, among other things.

In some embodiments, the aforementioned system further includes a database for storing the elected notification criteria and any further information received from the account holder.

Some embodiments provide a method of providing transaction processors with an ACH transaction alerting system, which includes the steps of receiving elections of notification criteria relating to a financial account managed by a financial institution and held by an account holder; receiving transaction data from a sender wherein the transaction data is associated with an underlying transaction involving the financial account; comparing the transaction data with the notification criteria relating to the financial account; suspending the underlying transaction associated with the transaction data if the notification criteria is satisfied, wherein suspension of the underlying transaction prevents the transaction from posting to the financial account; notifying the account holder of the underlying transaction associated with the transaction data; querying the account holder as to whether the underlying transaction is disputed, wherein if the transaction is disputed, then further information is requested from the account holder regarding the reason for disputing the transaction; permitting the underlying transaction to post to the financial account if the further information requested is not received within a preset period of time; and transmitting the reason for disputing the transaction to the sender of the transaction data.

In some embodiments, the aforementioned method further includes the step of querying the account holder as to whether the underlying transaction is authorized, wherein the underlying transaction is unsuspended if authorization is received from the account holder.

Some embodiments are directed to a computer program product, which includes a computer usable medium having a computer readable program code embodied therein adapted to be executed to implement a method for protecting account holders against fraudulent transactions. The computer readable program code can be configured for some or all of the following: providing an interface for an account holder to submit notification criteria, wherein the notification criteria relates to characteristics of financial transactions that involve an account in a financial institution and the account holder's notification preferences; analyzing incoming transaction data, wherein the transaction data is associated with an underlying financial transaction involving the account; comparing the transaction data with the notification criteria; notifying the account holder of the underlying transaction according to the notification preferences if the underlying transaction satisfies the notification criteria; providing an interface configured for querying the account holder as to whether the underlying transaction is disputed and receiving a response thereto; providing an interface for querying the account holder to obtain dispute information required by any applicable rules if a dispute of the underlying transaction is received by the account holder and receiving a response thereto; releasing the transaction data to the financial institution if the underlying transaction is not disputed by the account holder; and releasing the dispute information to the financial institution to facilitate the dispute process.

Some embodiments of the invention are directed to a method of protecting account holders against fraudulent transactions which include the steps of: receiving authorization criteria, wherein the authorization criteria relates to one or more characteristics associated with financial transactions that involve an account in a financial institution; receiving incoming transaction data wherein the incoming transaction data is associated with an underlying financial transaction involving the account; identifying the one or more characteristics associated with the incoming transaction relating to the authorization criteria received; identifying prior transactions with one or more characteristics corresponding with the identified one or more characteristics associated with the incoming transaction data; comparing the incoming transaction data with the authorization criteria; suspending the underlying transaction associated with the incoming transaction data if the authorization criteria is not satisfied; transmitting notification of the suspension to the account holder associated with the suspended underlying transaction data through a first communication method, wherein the transmitted notification includes a unique item of information; and permitting the suspended underlying transaction to proceed if the unique item of information is received through a second communication method. The underlying transactions may be any transaction, including ACH transactions and wire transfers. The underlying transactions may be ACH transactions or wire transfers in which the account holder is identified as the originator thereof.

In some embodiments, the aforementioned method may further include the steps of: receiving the unique item of information through the second communication method; permitting the suspended underlying transaction to proceed; adding the characteristics associated with the suspended underlying transaction to the prior transaction data; transmitting notification of the addition of the suspended underlying transaction to the prior transaction data, wherein the transmitted notification includes a unique item of information; and permitting the suspended underlying transaction to be added to the prior transaction data if the unique item of information is received through a second communication method.

In some embodiments, the authorization criteria may include the communication methods by which the account holder is to be notified.

In some embodiments, the aforementioned method further includes generating a unique item of information, which may be randomized, through any conventional method or system.

Some embodiments are directed to a system of protecting account holders against fraudulent transactions, which includes a data input device configured for (i) receiving authorization criteria, wherein the authorization criteria relates to one or more characteristics associated with financial transactions that involve an account in a financial institution; (ii) receiving incoming transaction data wherein the incoming transaction data is associated with an underlying financial transaction involving the account; a processor configured for (i) identifying the one or more characteristics associated with the incoming transaction relating to the authorization criteria received; (ii) identifying prior transactions with one or more characteristics corresponding with the identified one or more characteristics associated with the incoming transaction data; (iii) comparing the incoming transaction data with the authorization criteria; (iv) suspending the underlying transaction associated with the incoming transaction data if the authorization criteria is not satisfied; and a data output device configured for transmitting notification of the suspension to the account holder associated with the suspended underlying transaction data through a first communication method, wherein the transmitted notification includes a unique item of information and the underlying transaction will be permitted to proceed if the unique item of information is received through a second communication method.

The aforementioned system may further comprise a database for storing the authorization criteria, and or prior transaction data, and the data output device may be configured for communicating via SMS messages, MMS messages and phone calls.

Some embodiments of the invention are directed to systems and methods which, among other things, include receiving electronically transmitted transaction data including one or more items of data or information associated with executing a transaction involving a monetary amount, a payer and a payee, identifying prior transaction data involving the payer and the payee, comparing the transaction data with the prior transaction data, which may include comparing the one or more items of information with similar items of information associated with prior transactions, determining whether the selected items of information conform to or are within preset parameters based on the comparison between the transaction data and prior transaction data, executing the transaction if the selected items of information associated with the transaction data conform to the preset parameters, notifying the payer if the transaction data and prior transaction are not within preset parameters or if no prior transaction data is identified, wherein the payer may be notified through an alternate communication connection other than the communication connection used to transmit the transaction data, and transmitting unique authorization data to the payer through the alternate communication connection, wherein the unique authorization data may be used by the payer to either approve or reject the nonconforming transaction.

In some embodiments, the selected items of information include the payee financial institution and/or account information. In other embodiments, the selected items of information may include the monetary amount involved in the transaction. In yet other embodiments, the system and method may seek matches of selected items of information such as the payee financial institution or account. In other embodiments, the preset parameters are associated with the monetary amount involved in the transaction is within a preset range, such as less than ten thousand dollars, within a range as compared to amounts involved in historic transaction data, such as plus or minus one thousand dollars.

In some embodiments, the transaction may be suspended if the selected items of information do not match or there is no prior transaction data for the payee and payer. The suspension may be removed after a preset period of time.

In some embodiments, the transmission of unique payer authorization data, such as an alphanumeric password or picture, may be used only once by the payer to either access a secure system, such as an online website, in order to review and approve or disapprove of proposed transactions prior to execution thereof. In other embodiments, the notification includes an authorization key, which may be a password, picture or other coded information, which the payer may use to approve or disapprove of proposed transactions upon the payer accessing a secure account, which may be their existing account at the ODFI.

In some embodiments, the transmission of a unique payer login information or authorization key is made via SMS or text to a previously authorized cell phone number or other receiver capable of receiving SMS texts.

These and other aspects of the system and method of the subject invention and some embodiments thereof will become more readily apparent to those having ordinary skill in the art from the following detailed description of the invention and some embodiments thereof taken in conjunction with the drawings.

### BRIEF DESCRIPTION OF THE FIGURES

So that those having ordinary skill in the art to which at least some embodiments of the invention pertains will more readily understand how to make and use systems and methods in accordance therewith, such embodiments thereof will be described in enabling detail herein below with reference to the drawings, wherein:

FIG. 1 is a schematic representation illustrating some of the core functional components of a system constructed in accordance with some embodiments of the invention.

FIG. 2 is a flow diagram depicting a portion of the operational steps employed by a system and method formed in accordance with some embodiments of the invention, illustrating in particular, an exemplary ACH transaction intake, identification and suspension process, among other things.

FIG. 3 is a flow diagram depicting a portion of the operational steps employed by a system and method in accordance with some embodiments of the invention, illustrating in particular, an exemplary pending ACH transaction notification and dispute facilitation process, among other things.

FIG. 4 is a schematic representation illustrating some of the core functional components of a system constructed in accordance with another embodiment of the invention.

FIG. 5 is a flow diagram depicting a portion of the operational steps employed by a system and method in accordance with some embodiments of the invention, illustrating in particular, a notification system and method for authorizing incoming transactions using alternate communication methods, among other things.

FIG. 6 is a flow diagram depicting a portion of the operational steps employed by a system and method in accordance with some embodiments of the invention, illustrating in particular, a system and method for receiving instructions from an account holder or originator regarding suspended incoming transactions, among other things.

### DETAILED DESCRIPTION OF THE INVENTION

Some embodiments of the invention disclose a new and useful tool for facilitating ACH transactions and disputes of unauthorized ACH transactions, among other things, which may be used in conjunction with a computerized banking system.

Those skilled in the art will readily appreciate that a system in accordance with some embodiments of the invention may include various computer and network related software and hardware, that is, programs, operating systems, memory storage devices, data input/output devices, data processors, servers with links to data communication systems, wireless or otherwise, such as those which take the form of a local or wide area network, and a plurality of data transceiving terminals capable of interfacing with the network, such as personal computers, handheld devices, personal digital assistants (PDAs), cell phones or any other devices capable of displaying a graphical user interface.

Those skilled in the art will further appreciate that the particular types of communication network and devices, software and hardware are not vital to the full implementation of the embodiments described herein or other embodiments within the scope and spirit of the invention. It should be further understood that the type of communication network and devices, software and hardware may also vary based on the rapid advances in technology that are ongoing in the industry. In other words, the precise software and hardware configuration of the various embodiments of the invention may vary accordingly while still remaining within the scope and spirit of the invention.

For purposes of illustrating the features of some embodiments of the invention, the exemplary embodiments are described herein as being operated or hosted by a financial institution, and in particular, a financial institution that is designated as a “Receiving Depository Financial Institution” or RDFI. It should be understood that the operation of the method of some embodiments of the invention by such an entity is exemplary of the type of setting for which some embodiments of the invention are well-suited. Furthermore, it should be further understood that, depending on the context, an RDFl in one transaction may function as an ODFI in another transaction. Those skilled in the art will readily appreciate that the method of some embodiments of the invention may be operated by other entities, third parties, either in part or wholly integrated with other systems or used in other configurations within the spirit and scope of some embodiments of the invention.

For example, the system and method of some embodiments of the invention may be accessible for operation by a plurality of RDFIs through a communication network such as the world wide web while being hosted and maintained by an independent party at a separate location.

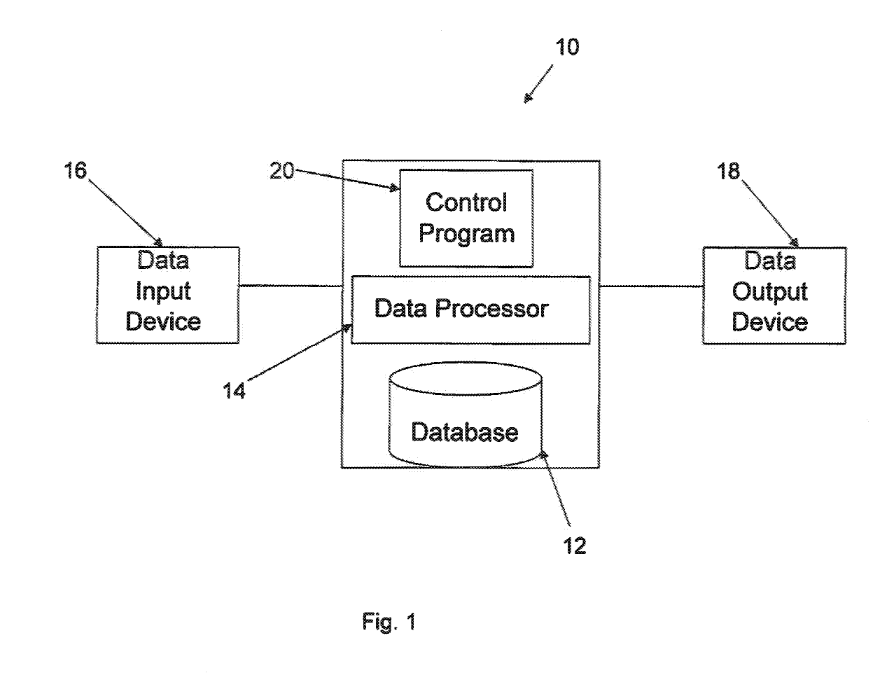

Referring now to the drawings herein FIG. 1 illustrates some of the core functional components of an exemplary system constructed in accordance with some embodiments of the invention and designated generally by the reference numeral 10. System 10 includes a data storage device or database 12, a data processor 14, a data input device 16, and a data output device 18. Each of these components of system 10 are operatively associated with one another via control program 20 and configured for managing communication and the flow of data through system 10, and processing of the data as necessary to implement the method of some embodiments of the invention.

As mentioned above, with the continuous and ongoing improvements in computer and electronic technology, many modifications may be made to the specific nature of hardware and/or software components required. Accordingly, one of skill in the art may select any hardware components that would rapidly and efficiently process the data and provide storage and communication as needed for the successful operation of some embodiments of the invention. For example, there may be a plurality of any of the components of system 10, such as multiple databases 12, processors 14, data input devices 16, data output devices 18, or programs 20.

Also, one or more of the system 10 components may have multiple uses, such as a combined data input/output device. Also, one or more components may be hosted, reside, or otherwise integrated with another system, such as program 20 being part of a computer system maintained by one or more financial institutions (such as RDFIs) or their transaction processors, which may be initially installed via an outside connection such as the Internet or world wide web and periodically updated as necessary, while the database 12, or portions of database 12, or other components of the system of some embodiments of the invention may be located separately and managed by an independent party for more than one financial institution.

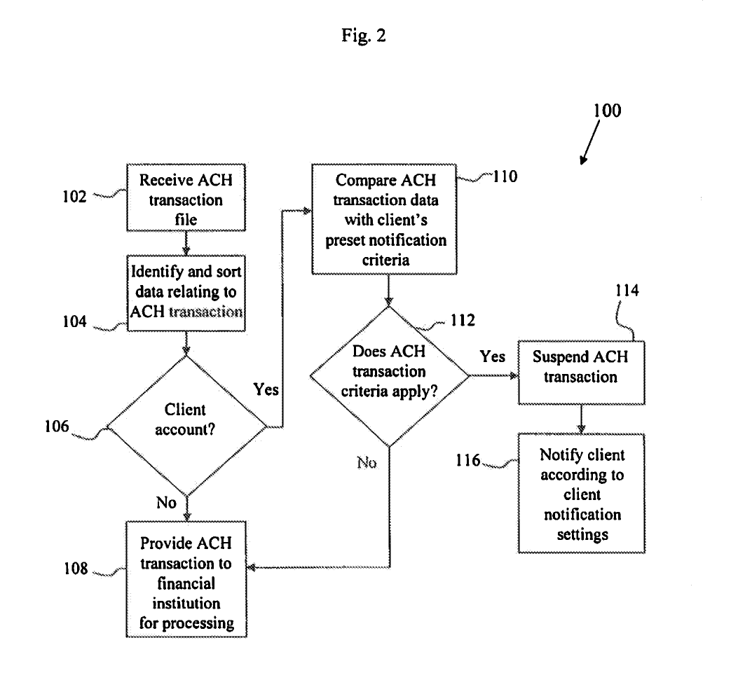

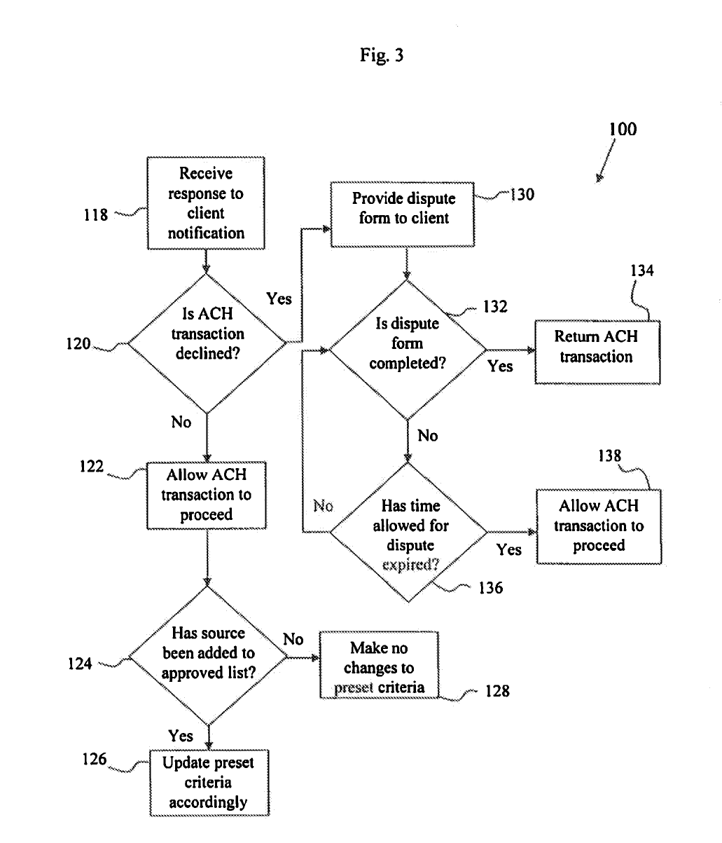

FIGS. 2-3 provide process flow diagrams which illustrate operational steps employed by an exemplary embodiment of the method of the invention. For illustrative purposes and convenience, the process steps will be described in conjunction with the exemplary system embodied by system 10 as shown in FIG. 1.

Referring now to FIG. 2, a flow diagram generally referred to by the reference numeral 100 illustrates an exemplary process according to some embodiments. An ACH transaction file is generated when an ACH operator and debit card processor initiate an ACH transaction intended to debit a customer's account with an RDFI. The RDFI associated with the customer's account, among other things, is identified, and transmission of the ACH transaction file would be received by data input device 16 at step 102.

In some embodiments, step 102 further involves system 10 generating and/or recording various data relating to the received ACH transaction file for storage in database 12. For example, the ACH transaction may be given a unique identification code, the date/time of its receipt may be recorded and a copy of the ACH transaction file may be added to a transaction history file maintained by system 10 in database 12.

At step 104, system 10, via control program 20 and processors 14, analyzes the ACH transaction file. In this embodiment, any non-ACH transactions are not considered by system 10. However, in other embodiments, system 10, or a system and method such as those discussed herein, may advantageously be employed for handling various electronic transactions in the same manner as ACH transactions.

In this embodiment, system 10 sorts the data and identifies information relating to the transaction. For example, system 10 may identify the customer or account holder involved, the account number and corresponding financial institution, the time and date of the transaction, the amount of the transaction, the originator (which may be a merchant or Point of Sale (POS) where the transaction occurred), the type of transaction, or any other identifying characteristic. In some embodiments, system 10 may be configured to remove some transactions immediately from consideration based on characteristics relating to the underlying transaction or transaction file. For example, system 10 may remove transaction files which have incorrect information or non-conforming data.

System 10 may also be configured to sort and identify the transaction by the National Automated Clearing House Association (NACHA) Standard Entry Class (SEC) code relating to the transaction. Transactions may have SEC codes such as: Cash Concentration or Disbursement (CCD) which is an ACH debit or credit transaction from or to a business account; Point-Of-Purchase (POP) which is used as an ACH debit transaction as a method of payment for the in-person purchase of goods or services by consumers. Prearranged Payment and Deposit (PPD) which includes transactions such as direct deposits and preauthorized bill payments; Re-presented Check (RCK) which is an ACH debit transaction used by ODFI's to re-present a check that has been processed through the check collection system and returned because of insufficient or uncollected funds; Telephone-Initiated Entry (TEL) applies to single entry debit transactions to a consumer's account pursuant to an oral authorization obtained from the consumer via telephone; Internet-Initiated Entry (WEB) which is a debit entry to a consumer account initiated by an ODFI pursuant to an authorization that is obtained from the consumer via the Internet; Back Office Conversion (BOC); and Accounts Receivable Truncated Check Debit (ARC) which is an ACFI debit of a check received in the mail and converted to an electronic item.

At step 106, control program 20 accesses data from database 12 to determine whether the account involved in the ACH transaction is held by a subscribing account holder. In some embodiments, the account holders must subscribe to methods and systems described herein as a service, which may be provided through their financial institution. In other embodiments, a financial institution may provide the service as a benefit to all account holders.

If for any reason the customer is not a subscribing account holder in step 106, then as shown in step 108 the ACH transaction file will bypass system 10 and be provided directly to the appropriate financial institution (RDFI) or made available to be retrieved by the RDFI, presumably for processing and resolution of the transaction. The processing may involve system 10 preparing a posting file and a return file, which will be retrieved by the RDFI's banking system and sent to the ACH operator, who may in turn transmit the return file to the ODFI involved in the transaction, to effectuate the appropriate credit or debit. The files may be provided immediately to the customer's financial institution or optionally held for a period of time before being released to the financial institution in step 108. If the customer is a subscribing account holder, then as shown in step 110 the transaction data obtained in step 104 will be compared with the account holder's preset notification criteria, which may be stored in database 12, to determine whether the transaction data satisfies any of the criteria for notifying the account holder in step 112.

In some embodiments, the account holder may enter the criteria relating to transactions for which they are to be notified via data input device 16. In some embodiments, typical criteria relating to transactions may be provided by system 10 as a list of options to be elected by the account holder. In some embodiments, account holders may select criteria that correspond with transaction characteristics which may be identifiable from the incoming ACH transaction file in step 104. For example, the preset criteria may relate to the date and time the transaction occurred, the amount of money involved, the originator involved, the type of transaction, whether the transaction involved use of a debit card, and/or the particular SEC code relating to the transaction, or types of transactions which may be deemed higher risk transactions based on one or more characteristics. The preset criteria selected by the account holder is stored in database 12 and used by system 10 to compare against incoming ACH transactions. Within system 10, the preset criteria may be written as computer code or language in any form, such as configurable rules or logic, which may be accessed by control program 20 and processed by processor 14.

In some embodiments, system 10 may also be configured to check the frequency of transactions having the same parameters in ascertaining whether any of the preset criteria has been satisfied. For example, account holders may preset criteria relating to the number of times an ACH transaction is received from a particular originator, and be notified when an ACH transaction is received that equals the designated number.

It is envisioned that account holders may preset the notification criteria so that all ACH transactions are to be suspended until approved. Account holders may then add originators to an approved list so that ACH transactions submitted by such originators will not be suspended. As another example, account holders may preset criteria relating to the number of transactions associated with one or more specific SEC codes, and be notified if an ACH transaction is received that equals the designated number for the specific SEC code.

If in step 112, system 10 discovers that there are no preset notification criteria relating to the ACH transaction in question or the ACH transaction in question does not satisfy any preset notification criteria, then the transaction file or posting file is forwarded to the appropriate financial institution in step 108. If appropriate, a return file is also forwarded to the ACH Operator (who forwards the file on to the ODFI) to ultimately resolve the credit or debit at the RDFI and ODFI of the parties involved in the transaction. However, if in step 112 system 10 finds that there are preset notification criteria which are satisfied by the details or characteristics of the ACH transaction, then the ACH transaction in question may be suspended in step 114 and the account holder is notified of the ACH transaction in step 116 according to the account holder's notification settings. It should be understood that the suspension of the ACH transaction means the transaction will not post to the account, that is, either credit or debit any account in an RDFI or ODFI. In this embodiment, the suspension of the ACH transaction and satisfaction of the preset notification criteria is recognized by system 10, and data regarding the same, which may include the transaction file, is stored in a “centralized warehouse,” that is, stored in database 12 or other memory associated with system 10. In other embodiments, the transaction may be allowed to proceed even if the preset notification is satisfied but the account will be credited if the transaction is disputed thereafter and the dispute is completed within any required period of time.

As described above, the preset criteria sets forth the characteristics of incoming ACH transactions for which the account holder is to be notified. In this embodiment, the preset notification criteria in system 10 further prescribes the manner in which the account holder of the ACH transaction in question is to be notified. The account holder may be notified upon satisfaction of the preset criteria via one or more data output devices such as data output device 18. For example, the account holder may be notified through any conventional method, such as e-mail, fax, phone call with automated voice response and recognition system, short message service (SMS) text, or combinations thereof, and to multiple parties. In this embodiment, the ACH transaction in question will be suspended while the account holder is notified that an incoming ACH transaction has satisfied the preset criteria. In other embodiments, the account holder may elect to be notified of an incoming ACH transaction that satisfies the preset criteria but further elect that the transaction is not to be suspended.

In some embodiments, the account holder will receive an indication within the notification of the particular preset criteria which was satisfied by the characteristics of the ACH transaction in question, and may choose different notification methods depending on which of the preset criteria is satisfied. For example, if the preset criteria for a certain SEC code is satisfied, the account holder may choose to be notified through e-mail, whereas if a certain threshold value is exceeded, the account holder may elect to be notified via SMS. It should be understood that in some embodiments of the invention the notification feature may be limited by the RDFI as necessary, for example, to reduce the burden or expense of operating a system such as system 10. However, the means of communication are not limited to any particular methods or devices. Considering the rapid advances in technology, any communication devices or methods may be employed as necessary to notify the account holder within any applicable time limits.

The account holder's response to the notification of an ACH transaction satisfying the preset criteria is received by a data input device such as data input device 16 associated with system 10 in step 118. In some embodiments, the response is provided via the same method as the notification. For example, if using SMS, the account holder may reply with to the question of whether to dispute the ACH transaction or not by an SMS text of either “yes” or “no.” If using a phone call with an automated voice response and recognition system, then the account holder may speak their response or indicate by touch tone, that is, by pressing certain buttons on a touch tone phone. If account holders elect to receive an e-mail notification of an incoming suspended ACH transaction which may appear as follows:

In this example, if reject is selected, a message may also appear or sent via email thereafter in accordance with the rules regarding rejecting or “returning” ACH transactions. The rules regarding returns of ACH transactions may vary depending on the characteristics relating to the transaction itself, such as the SEC code.

In some embodiments, the account holder may not be required to approve the ACH transaction in order for the transaction to proceed, but rather must affirmatively reject or decline the ACH transaction for it to be suspended. In this embodiment, system 10 may allow the transaction to proceed if the account holder does not reject within a preset period of time. If the account holder responds by approving the transaction or does not decline the ACH transaction in question in step 120 within the preset period of time, then in step 122 the ACH transaction is released to a financial institution for posting or processing against the account of the account holder involved in the ACH transaction. The preset period of time may be the same for each ACH transaction or varying depending on the characteristics of the ACH transaction or the type of account holder involved, that is, whether the account holder is a business entity or individual. Once the transaction is permitted to proceed, the ACH transaction file may be accessed from database 12 or the centralized warehouse. The ACH file may be in the appropriate ACH transaction format or otherwise made ready for import to the core banking system associated with the RDFI. The RDFI may retrieve the file for posting and forward to the ACH operator as necessary. 10062] In some embodiments, if the account holder response affirmatively allows the ACH transaction, the account holder may also be asked whether they would like to accept the ACH transaction singularly, or be provided with the option to indicate acceptance of further ACH transactions having similar characteristics. For example, the account holder may indicate that transactions from the same source should be automatically allowed in the future. In some embodiments, the account holder may indicate that transactions involving the same monetary amount or similar amounts, or any other of the characteristics associated with ACH transactions determinable in step 104, should be automatically allowed. If the account holder selects such options, then the account holder's preset notification criteria will be updated in database 12 accordingly.

In the embodiment shown in FIG. 3, system 10 poses the additional query to the account holder as to whether the source or originator from which the ACH transaction derives should be added to the account holder's approved originator list in step 124. The query may be provided to the account holder via a data output device such as data output device 18 or any of the communication methods and systems described herein. If the account holder indicates that the originator should be listed as automatically approved, then the account holder's preset notification criteria in database 12 is updated by control program 20 accordingly in step 126. If the account holder does not indicate that the originator should be on the approved list then no changes are made as shown in step 128. The response to this query may be received by the data input device 16 or any other data input devices associated with system 10.

After querying the account holder as to whether the originator or source from which the ACH transaction derives should be added to the account holder's approved list, it should be understood and readily apparent that system 10 may present the query to the account holder along with information taken from the transaction data, such as in a pre-populated screen including the source name, identification and amount, for subsequent confirmation by the account holder that the source should be added to the approved originator list and criteria should be changes as described above, as well as further query the account holder regarding additional parameters relating to future transactions received from the source.

In some embodiments, the account holder may place an originator on an approved list while still electing to be notified if certain criteria are satisfied in relation to that originator, such as the frequency or monetary amount of ACH transactions within a given time period. The present notification criteria would be changed accordingly, and the account holder would not be notified of ACH transactions involving the approved originator unless the notification criteria were met.

If the account holder declines the ACH transaction in step 120, then the ACH transaction will remain suspended in the centralized warehouse or database 12 and the account holder will be provided with a WSUPP form or otherwise be able to dispute the transaction in step 130 using any other appropriate form. In some embodiments, the account holder may provide a reason for declining the transaction, such as for example, unauthorized, improper, incorrect, ineligible, stop payment or revoked. System 10 may also be configured to require an affirmative response as to the reason for declining the transaction and confirmation thereof using a valid authentication code to comply with applicable law.

The following is an example of a current version of a WSUPP form which can be automatically provided to an account holder by some embodiments of the invention via data output device 18 or using a data entry screen through a graphical or telephonic, VRU user interface. In this example, the WSUPP is based on the rejection of a PPD by the account holder. The account holder may be required to complete and submit the entire WSUPP form in some embodiments of the invention. However, some embodiments of the invention may be configured to include user-friendly prompts to assist the account holder in entering information required by NACHA rules based on the type of ACH transaction. For example, in a first field, the account holder may be provided with the following options:

The account holder may enter information in the appropriate fields in any conventional manner, such as by depressing a graphical representation of a button on a graphical user interface or by keying information into a telephonic VRU, and then submit the completed form electronically. In some embodiments, system 10 requires submission, acceptance and confirmation in compliance with various regulations, such as the Electronic Signatures in Global and National Commerce Act (ESIGN).

The WSUPP form and corresponding dispute process is the current method for disputing ACH transactions. It should be readily apparent that it is within the scope of system 10, and any other systems and methods described herein, to support any other dispute process involving ACH transactions or electronic transactions generally. For example, system 10 may be configured to provide account holders with the form known as the Written Statement of Unauthorized Debit pursuant to possible rule changes regarding ACH transactions. Thus, system 10 is not limited to the currently required procedures, regulations and WSUPP form, but may be configured to support any future dispute process for ACH transactions should there be changes to the current procedures and/or WSUPP form.

The manner in which the WSUPP form is provided to the account holder in step 130 may vary depending at least partially on the way in which the dispute process was initiated by the account holder, among other things. For example, if the account holder initiated the dispute process by e-mail, then the account holder may be provided with a hyperlink connection to an electronic version of the WSUPP form. Alternatively, the notification e-mail may include a WSUPP from which may be submitted along with the account holder's response, assuming that response is not an approval. If the account holder is notified by SMS, then the account holder may be directed to a website or receive an e-mail with a hyperlink directing the account holder to a website from which a WSUPP form may be completed. It should be readily apparent that system 10 can be configured to provide a variety options which facilitate the dispute process according to the applicable rules while also providing convenient features for the account holder and RDFI.

If the WSUPP form, or other required procedure, is completed in step 132, then either the ACH transaction file or a return file is returned to the ACH operator via data output device 18 and the appropriate parties are notified of the dispute in step 134. System 10 may also maintain records and track all disputes initiated by the account holders, which may be stored in database 12. In some embodiments, the account holder will be provided with a limited amount of time to complete the WSUPP form (or other vehicle for formalizing the dispute process) after declining the ACH transaction in question, according to any applicable rules. The period for response will be communicated to the account holder by system 10 so that the account holder is well aware of the obligation to meet this deadline.

As shown in step 136, if the period for responding has not expired, system 10 continues to wait for the form to be completed in step 132. If the time for finalizing the WSUPP form has expired, then in step 138 the ACH transaction will be removed from its suspended state. A return file will be prepared by system 10 for the RDFI to use for posting against the account of the corresponding account holder and forwarding to the ACH Operator. In some embodiments, if the account holder completes the dispute initiation process after the deadline, then the account holder will be notified that the time for responding has expired and instructed to contact their financial institution (the RDFI) directly if they wish to dispute the debit.

If the transaction was declined and the WSUPP form completed prior to the expiry of the applicable time period, the completed WSUPP form will be stored in database 12. A return item or file may be automatically generated by system 10 using the appropriate return reason code, if applicable, and transmitted via data output device 18 in the appropriate ACH format to the RDFI and/or ACH operator. Examples of return reason codes include codes for issues such as unauthorized debit, authorization revoked by consumer, and payment stopped.

System 10 may also automatically prepare and provide return files on any ACH transactions that proceed, including affirmatively authorized transactions, as may be required by applicable rules to the RDFI. In such embodiments, a RDFI may receive and process the account holder's ACH transaction posting file or debit processing instructions as provided in the file release instructions by system 10 via data output device 18. For example, the ACH transaction file release instructions may show that the account holder affirmatively authorized the transaction or did not decline the transaction within the given time period. In this case, the RDFI will receive the posting file and allow the ACH transaction to proceed. If the file shows that the account holder had declined the transaction, then the RDFI receiving the file will not allow the transaction to proceed. The return file may be transmitted to the ACH operator in both cases, that is, whether the transaction proceeds or is declined from the RDFI. An ACH operator that receives an ACH return file will typically forward the information to the ODFI without interference. If the ACH transaction was authorized by the account holder, then the ODFI will not request a WSUPP and the process will end. If the return file reveals that the account holder has declined the ACH transaction, then the ODFI will likely request the corresponding completed WSUPP form. In some embodiments, the preparation of files for communication is handled by data processors 14 and program 20.

The ODE′ request will be received by data input device 16 of system 10 which may be residing at the RDFI, or the portion of system 10 hosted at the RDFI which is also configured for receiving such requests. Upon receipt, the completed WSUPP relating to the ACH transaction in question which was received by system 10 and stored in database 12 in step 134 will be located. A copy of the WSUPP form may then be forwarded to the ODFI via data output device 18, upon permission being granted by the RDFI, if such permission is necessary. If a WSUPP from has not been completed, system 10 will track the date and time of the ODFI request and send reminders to the RDFI and account holder as necessary.

The RDFI may additionally request proof of the account holder's authorization from the ODFI, via a requested authorization for receipt form or other applicable form. System 10 is configured to forward the appropriate request as well as track the date and time of actions taken in the matter, such as the ODFI request for a WSUPP, in order to send reminders to the ODFI or others regarding deadlines for further responses and obligations under the NACHA rules.

In some embodiments, a system 110, which is similar to system 10, is discussed generally below, and also referred to hereinafter as the “ACH Alert” system. The ACH Alert system comprises an Internet or web-based service which can be utilized by financial institutions and/or their third party processors to offer ACH fraud protection to account holders (such as corporations and consumers) through graphical user interfaces or “screens,” and may be configured similarly to system 10 and include components as shown in FIG. 1.

As mentioned above with regard to system 10, part or all of the functionality of the ACH Alert system and core components may be located at one site, such as the offices of the third party processor for example. Alternatively, the ACH Alert system may be a fully hosted application operated by an independent entity offsite and made available to a third party processor through conventional hosting methods.

Although financial institutions may be the primary commercial account holder and user of the ACH Alert system, individual account holders that maintain accounts with the financial institution may also be provided access to their individual accounts and features of the ACH Alert system if permitted by their financial institution. Thus, the ACH Alert system may be configured to support a multi-tier structure of one or more relationships with third party transaction processors, financial institutions, and account holders. It should be understood that a third party processor as described herein may be an independent entity, subgroup or wholly owned subsidiary of a financial institution or other business to whom financial institutions outsource their core processing needs.

The ACH Alert system can provide support for multiple third party transaction processors, with multiple financial institutions associated with each third party processor and multiple account holders under each financial institution. Each third party transaction processor may maintain transaction records in their own tables/database which may be inaccessible by unauthorized users as set by the processor. The ACH Alert system may incorporate industry standard security measures, such as multi-factor authentication where applicable, strong passwords, changing passwords, or other security measures known in the art, as well as using encryption and security techniques to secure sensitive data in the database and transmit data between the parties and the ACH Alert system.

The ACH Alert system may support three different processing levels, each of which may be linked together in a database for the third party processor, financial institution and account holder, as in a “grandparent, parent, child” relationship, while having varied access to different features of the system. The ACH Alert system can be configured to allow third party processors to define and set specific user roles and privileges for account holders and/or financial institutions that make use of the system. The ACH Alert system may also support user audit and tracking capability for third party processors. Access by account holders may be obtained through any secure method, such as manual entry of identification and password information, contract number or by a trusted authentication from a third party application for example.

In some embodiments, the ACH Alert System includes user-friendly features, such as a wizard-type set up or online help features explaining the use of each field as well as a complete tutorial customized for each type of user, including the third party processor, financial institution and account holder, depending on their respective needs and use of the system. It should also be understood that the system may include various screen interfaces for accessing the system, and such interfaces may differ depending on whether the accessing party is a third party processer, financial institution or account holder. In some embodiments, notifications may include e-mails with a URL or hyperlinks to sites that illustrate the account holder's account, the ACH transaction in question, among other things, and allow the account holder to immediately authorize or complete the appropriate dispute forms, as necessary.

As described above, the ACH Alert system allows third party processors to offer and/or support the ACH Alert system to their financial institution clients if desired. For example, the processor may manage system features such as providing for the entry and validation of the third party processor routing number and name, specifying which financial institutions are subscribing or participating in the ACH Alert system, defining incoming and outgoing formats, and specify discreet or comingled file acceptance. The processor can also grant financial institutions with the ability to customize access levels for their own account holders if desired.

Some of the functions available to third party processors further include: supporting entry of the processor's Electronic Transaction Identifier (ETl) and/or routing number and name, which uniquely identifies the processor in the database; defining the ACH file type they will load to the system and the format; defining the specific format of ACH file they need the system to build to feed into their core system; and supporting the automatic creation of general ledger entries for account balancing purposes.

A third party processor may either use the ACH Alert system to set for themselves or provide the financial institutions with capabilities such as, setting the default suspend, posting, or notification rules or other variables. Thus, the third party processor may allow only certain preset notification criteria pertaining to incoming transactions to be elected, either by the financial institutions or account holders. The third party processor may also give the financial institution the option to defer the selection of such variables or other rules to the subscribing account holders themselves. A third party processor may also either maintain for themselves or provide the financial institutions with control over options relating to the preset notification criteria, such as which characteristics ACH transactions may be identified by or which notification methods are permitted. The financial institution may also be allowed to set certain parameters, such as the appropriate WSUPP return deadline, so long as it maintains within applicable regulations, and customize the period of time the transaction is suspended, such as by a specific time of day or number of hours from the transaction time or file loading time.

For example, NACHA rules allow a corporate account holder up to two (2) days from the settlement date to dispute unauthorized transactions and the consumer account holder has sixty (60) days from the settlement date to dispute unauthorized transactions. A financial institution may want to modify these timelines in the ACH Alert system to allow adequate time to send back to the ACH Operator based on their processing routines. A financial institution can also use the system to place controls on the number of unauthorized transactions that can be returned by a single account holder within a set period. The third party processor may choose to allow the financial institutions to customize such options.

The financial institutions may also make use of the system to configure various rules for transaction handling/parsing prior to notification for all subscribing account holders. For example, a third party processor may permit a financial institution to send automated pre-note notifications, suspend posting of ACH transactions for all subscribing account holders, and warehouse them until a preset deadline but before posting to an account.

The ACH Alert system may also allow for the posting of incoming ACH transactions to accounts but permit the account holder to dispute the transaction within a preset period of time, in which case the funds will be credited to the account if a dispute is initiated within time. As mentioned above, some financial institutions may want to notify their account holders for transactions that carry specific SEC codes, or for what they deem to be higher risk transactions. The system further provides third party processors with the ability to allow financial institutions to make general ledger entries automatically, and balance files or entries where applicable.

In some embodiments, the system default is to require a consumer account holder to electronically complete a WSUPP before an ACH transaction dispute is returned to the ACH operator by the system. The third party processor may permit the financial institution to override this requirement and allow an account holder to execute a disputed return without having already completed the WSUPP. The system may then notify the appropriate parties of all transactions that have been returned as disputed and for which the WSUPP has not been completed. The third party processor or financial institution may configure the system so that privileges are suspended for account holders who have not completed the WSUPP form, or followed other dispute procedure, within a preset period of time from initiating a dispute.

Account holders using the ACH Alert system may be allowed by either the third party processor or the financial institution to access the system and set their own preset criteria rules, as well as maintain and edit their profiles using any suitable secure access method, such as contract number or a user identification and password. In some embodiments, account holders are granted access to the ACH Alert system through an existing online banking system used with their financial institution, and the two systems are virtually indistinguishable. In other embodiments, account holders may access the ACH Alert system independently of their online banking system.

A third party processor of financial institution may typically allow the ACH Alert system to provide the account holder with the capability to select their own preset notification criteria for ACH transactions and multiple methods of notification (and multiple contacts under each method of notification), depending on the particular transaction, or in other words, the particular preset criteria satisfied. The options may include such elections as “all debits,” or relate to specific originators, the amount of money involved or standard entry class (SEC) code.

For example, it is envisioned that account holders may initially choose to be notified by the ACH Alert system for all incoming ACH transactions, which may be accomplished by selecting the “all debits” option. The ACH Alert system will maintain a record or history of payments which are stored in an associated database, such as database 12. Upon receiving notification of incoming transactions, the account holder may access the system and select the entities involved in the transactions which are to be automatically authorized in the future. The account holder may also choose to be notified of incoming ACH transactions without simultaneously suspending the transaction.

The ACH Alert system may provide for a variety of management functions relating to the ACH transaction files, such as parsing of files, filtering and warehousing of files, and the building or rebuilding of files, among other things, The ACH Alert system may also return files to the ACH Operator if the entries are rejected, and create of account or banking offsets for transactions that have posted but the return deadline has not expired.

The system may also provide for automated electronic exchange of the WSUPP, authorization request and proof of authorizations between participating depository financial institutions (ODFI's and RDFI's) with a tickler system to notify a financial institution if they are nearing the deadline to respond to an inquiry. The system can also be configured to generate a series of balancing reports covering a variety of subjects, such as suspended items, approved items, no response items, and rejected items.

Some embodiments may include what is referred to as a centralized warehouse, which can be embodied by an internal or external database, among other things. The warehouse can accept and store eligible information generated by the application of the system of some embodiments of the invention as well as responses from the financial institutions, either on-site in a host system or via communication to an external database. The warehouse can further be configured to release ACH transaction files for retrieval processing by the applicable financial institutions at the suspend deadline.

In some embodiments, upon the ACH transaction either being authorized or expiry of the relevant suspension deadline for indicating a dispute or completing the dispute form, the ACH Alert system will prepare ACH transaction files in the appropriate format, such as return and posting files, for the RDFI's to incorporate into their core banking system and forward to ACH operators, as necessary.

In another embodiment, the invention is directed to banking systems and methods, and in particular, automated banking systems and methods for the secure transfer of funds between two parties.

In some embodiments, system and methods described herein may be operated by a third party on behalf of one or more financial institutions to be optionally offered or otherwise provided to payers, such as corporate entities (which may be referred to herein as “originators,” “payers,” “payors” or “account holders”) in connection with their accounts at a financial institution. Some of these embodiments are directed to systems and methods detecting and notifying originators of possibly suspect transactions in which they are the payor, that is, transactions in which the originator is the account holder “originating” a transaction involving the originator making a payment to a third party from their own account. It should be understood that these embodiments may be employed alone or in combination with, any of the other embodiments described herein. Those skilled in the art will readily appreciate that the system and method described herein may also be operated by the financial institutions, payers or other entities, either in part or wholly integrated with other systems, or used in other configurations within the spirit and scope the invention.

As described above, transaction data will be transmitted from originators under normal circumstances. However, if the originator's system is compromised, unauthorized transaction data may be transmitted from the originators, or perhaps the transaction data may be configured to appear as if transmitted from the originator. Upon receiving transaction data, the originator may be identified and compared with a list of participating originators before being processed by the system. In some embodiments, the financial institution may offer the system of this embodiment to only some originators or account holders. For example, the financial institutions may choose to offer the system described herein as an additional optional security feature pursuant to an additional charge. Thus, the system may further be configured to review the incoming transaction data to identify originators receiving notification and associated services as described herein. Transaction data for those originators that are not identified as receiving services will be allowed to pass through for further execution.

In some embodiments, originators are provided with an initial user interface by the financial institution for selecting the authorization criteria, that is, the parameters and/or items of transaction data by which prior transactions involving the originator should be identified and compared with newly received transactions, as well as the notification methods and receivers. This user interface can be provided temporarily upon first setting up the system to prevent unauthorized changes to the initial selections of authorization criteria. However, other methods may be used to enter the initial selections. The financial institution may require that a representative of the originator provide such initial selection data on-site at the financial institution, or that changes thereafter may only be made on-site. Alternatively, all administrative features, options and settings relating to an originator's account at an ODFI, including authorization criteria, may be operated and controlled by the financial institution and populated by information provided by the originator.

Upon receiving incoming transaction data, the transaction details, including various items of information such as the payee name, date, transaction amount, financial institutions involved, etc., will be identified. The authorization criteria may set forth a combination of requirements to be met, which may include comparison of incoming transaction data with prior transaction data. Prior transaction data may be retrieved for the purpose of comparing the prior transaction date with the incoming transaction data to assist in determining whether the authorization criteria is satisfied. The authorization criteria may designate specific items of transaction information or characteristics associated with incoming transactions which will are to be used to identify the prior transactions for comparison, which for example, may include any transactions involving the same account or other originator accounts.

The authorization criteria may further identify particular characteristics of the incoming transaction, the satisfaction of which may allow the transaction to automatically proceed to finalization. Conversely, the failure to satisfy the authorization criteria may result in the suspension of the incoming transaction. Alternatively, the transaction may be allowed to proceed, thus posting to the originator's account. The originator may subsequently indicate that the transaction is fraudulent and obtain a credit therefor.

In some embodiments, the authorization criteria may identify the items or characteristics associated with the incoming transaction which should be used to identify prior transactions for comparison therewith, and if the characteristics correspond with the characteristics associated with the prior transaction, the incoming transaction will satisfy the authorization criteria. For example, a characteristic set by the authorization criteria for comparison may be the payee name. Prior transactions involving the originator and the payee may then be identified. The authorization criteria may include preset parameters relating to the amount of the transaction for this payee, similar payees, or generally. If the amount involved in the incoming transaction is within the parameters set by the authorization criteria, the transaction will be allowed to proceed. If the amount is outside those parameters, the transaction will be suspended.

The authorization criteria may be set to allow incoming transactions to proceed if certain characteristics match prior transaction data. For example, the payee name, payee account number and amount associated with the incoming transaction data may be used to identify prior transaction data, and the transaction will be automatically allowed if such information matches prior transaction data. Certain payees may be assigned to groups which require that further criteria be met, such as the monetary amount must be below a certain amount or at least a preset number of days from a prior transaction involving the same monetary amount or payee. Thus, the originator would be notified if a payee receiving regular payments from the originator were to receive a payment on an unusual date or outside of the usual order of payments. A system according to some embodiments may therefore be configured to query further, such as comparing the amount only if certain characteristics of the incoming transaction data do not match or correspond with prior transaction data. For example, the amount may be compared with preset parameters only if the payee account number or bank information differs from prior transactions with that payee.

In another example, the authorization criteria may be independent of prior transactions, as the originator may select to suspend all transactions if the amount involved in the transaction is outside a preset range or based on the type of the transaction, such as a wire transfer. It should be readily apparent that the comparison of the transaction received with prior transactions may be configured in a variety of ways and still be within the spirit and scope of the invention.

The authorization criteria may also provide for the authorization or suspension of incoming transactions for which no prior transaction data is identified. The originator may set authorization criteria which suspends all such incoming transactions or authorizes such transactions based on comparing the characteristics of the incoming transaction with preset parameters associated with the authorization criteria. For example, the authorization criteria may be set to allow incoming transactions for which there is no prior transaction data if the transaction amount is less than a certain amount. Other preset authorization criteria may include the transaction date or other items of information associated with transactions.

As discussed herein, the incoming transaction will be suspended upon failure to satisfy the authorization criteria. Originators may select the notification method for when a transaction is suspended upon initially submitting the authorization criteria. The notification method may include SMS, text messaging, MMS, automated voice messaging, voice response, email, etc., which may be sent via data output device 218. The originator will also select the receiver for notifications. Alternatively, the information regarding notification methods and receivers may be input through a user interface controlled by the financial institution from information provided by the originator.

For example, if notification by SMS or MMS is selected, then a cell phone number will be submitted. The notification method is preferably through one or more communication methods which either alternate or otherwise differ from the communication connection used by the incoming transaction data. For example, transaction data may be sent using a first communication method, such as electronically online, the Internet, wire transfer system or through the ACH network, whereas the notification may be sent via a second communication method, such as SMS, MMS, email or automated phone call, or combinations thereof. The notification may be sent via one or more communication methods.

The notification method may include alternate methods to, among other things, facilitate the detection and neutralization of fraudulent transactions, which may be initiated as a result of account-hijacking software, malware or other criminal activity. For example, if more than one notification method is provided, the system may randomly choose one or all of the alternate communication methods to send notification. The originator may set the notification method or methods such that a series of notifications are sent to individuals or notification receivers.

The notification will include a unique key, data, message or item of information, which must be received by the system to “unsuspend” or permit the transaction to proceed. The key may contain information which the originator can use to authorize the suspended transaction. For example, the key may contain a picture and the originator will be asked to identify the content of the picture to authorize the suspended transaction. Alternatively, the key may be a randomized alphanumeric code, utilize information about the originator, or otherwise use information or employ other methods as a verification of identity prior to allowing the suspended transaction to be authorized.

The unique key may be a login and/or password. In some embodiments, the unique key will only function to allow access once. Thus, in such embodiments, every suspended transaction will prompt transmittal of a notification containing a newly generated unique key. In some embodiments, the system may use a similar notification with authorization key upon receiving an update to the authorization criteria, in which the update will only be permitted upon entry of the key.

In some embodiments, the notification receiver may log into system using a graphical user interface, but they will be required to enter the key in order to authorize the suspended transaction. In some embodiments, one or more of notification receivers must enter the key to permit a suspended transaction, as specified by the originator. Furthermore, one or more keys may be sent, in which one or all must be received by the system prior to authorizing the suspended transaction.

In some embodiments, once a suspended transaction is authorized, the system may inquire whether similar transactions should be authorized in the future or the authorization criteria should be adjusted accordingly. Alternatively, the system automatically includes the transaction among the prior transaction data stored in memory for subsequent comparative purposes. In either embodiment, the system may transmit a confirmation notification which may include another unique key as described above, which must be entered to effectuate the change to the initial selection data.

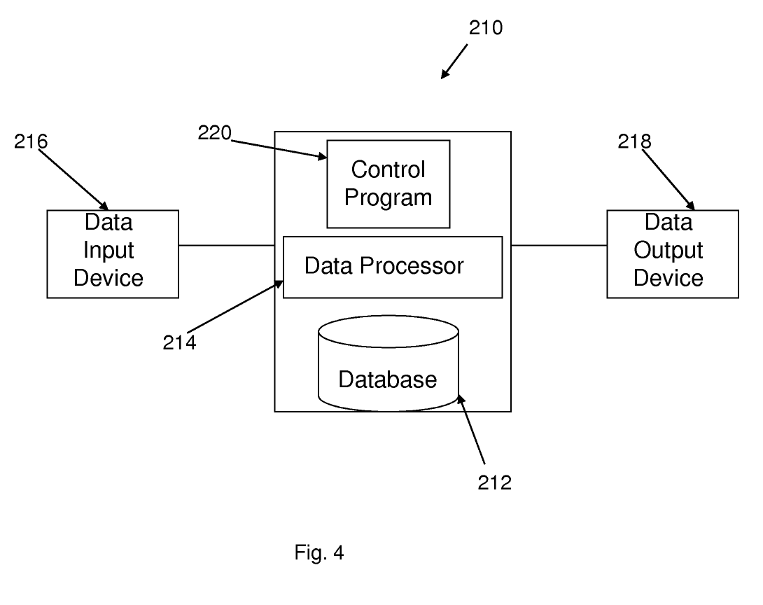

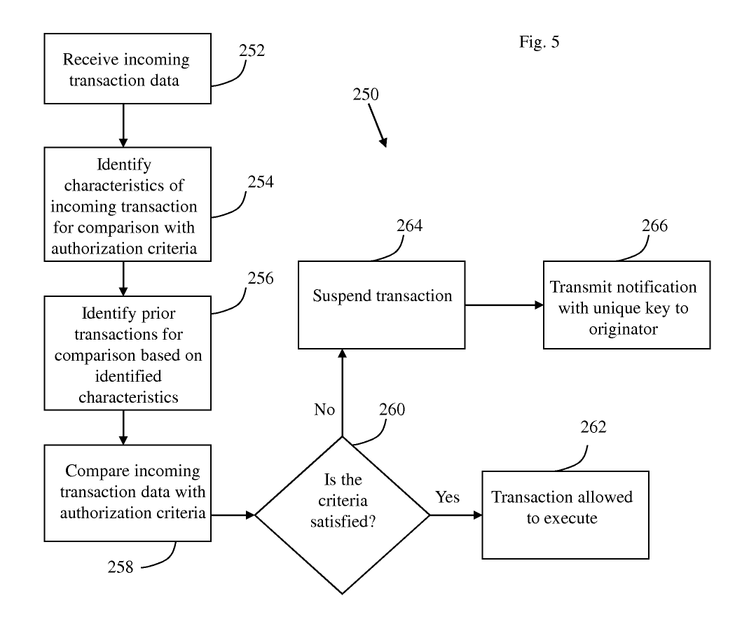

FIGS. 4 and 5 illustrate an embodiment of the aforementioned notification system. The initial selection of authorization criteria is received by system 210 and stored in database 212 for use by program 220 via processor 214. System 210 receives incoming transaction data through data input device 216 and determines the transaction details, including various items of information such as the payee name, date, transaction amount, financial institutions involved, etc. The authorization criteria may designate the items of information which system 210 will use to locate and identify prior transactions either stored in database 212 or stored in another database for subsequent comparison with the newly received incoming transaction data.

The system may be configured such that the authorization criteria may relate to identifying the payee as being part of a preset group. Thus, a transaction involving a new payee in that group may be compared with prior transactions involving other payees in the group, rather than the individual payee. The group may relate to a job category or type, and system 210 may compare the incoming transaction data with prior transaction data for other payees in that job category to determine whether the amount involved in the incoming transaction is within a preset range for that category as set by the initial selection data. Likewise, the items may include a type of payment, such as a bonus, which may then be compared to authorization criteria relating to that type of payment.

If the incoming suspended transaction is a fraudulent transaction, the notification receiver may indicate the same to the financial institution so that the appropriate actions may be taken. The indication of a fraudulent transaction may also require entry or otherwise submittal of the unique key.

FIG. 5 illustrates operational steps of an embodiment of the invention generally indicated by reference number 250. For illustrative purposes, the steps will be described in conjunction with the exemplary system embodied by system 210 as shown in FIG. 4.

In operation, an incoming transaction involving an originator and a payee is received by system 210 as shown in step 252. System 210 either receives the transaction data as it is positioned to identify and filter such transactions from the incoming transactions, or the transaction data is directed to system 210 from the originator's financial institution.

In step 254, control program 220 will identify the characteristics associated with the incoming transaction to be used for identifying prior transaction data and comparison with the authorization criteria. System 210 therefore identifies whichever relevant items will be necessary, such as the amount, date, account number, routing number, payee information, etc., and searches database 212 via processor 214 for prior transactions accordingly in step 256. For example, if the transaction item is the payee name, then prior transactions involving the originator or specific account and payee are identified.

As shown by step 258, the incoming transaction data is compared with the authorization criteria, which may require that certain characteristics of the incoming transaction data match or correspond with the prior transaction data identified.

For example, authorization criteria may indicate that transactions for that payee or similar payees should occur on or around the same day every month as prior transactions (e.g., a date range equal to two days), then system 210 will identify prior transactions with the same payee, if any, in step 256, and then compare the dates associated with the prior transactions with the date of the incoming transaction in step 258. Similarly, if the preset criteria indicate that transactions for that payee or similar payees should not exceed a particular monetary amount, then system 210 will identify the prior transactions for that payee in step 256 and compare the amount involved in the transaction received with the amount involved in the prior transactions identified in step 258. The selections, parameters and/or criteria may be written as computer code or language in any form, such as configurable rules or logic, which are accessible by control program 220 and processed by processor 214.

As shown by step 260, if the authorization criteria are satisfied, the incoming transaction is allowed to execute in step 262. Thus, the transaction will be allowed to finalize and affect the accounts involved or forwarded to the ODFI for execution, depending on the manner in which system 210 is employed.

If system 210 determines that the authorization criteria are not satisfied in step 260, then the transaction will be suspended in step 264. Once a transaction is suspended, system 210 then sends out a notification in step 266 to the originator using the one or more preset methods of communication set forth initially with the authorization criteria.

The notification transmitted in step 266 will include the key which must be entered or otherwise submitted prior to permitting the transaction. In some embodiments, the transaction will be suspended indefinitely, while in others a time period may be set by which it will be permitted if no indication of fraud or permission is indicated through entry of the key.

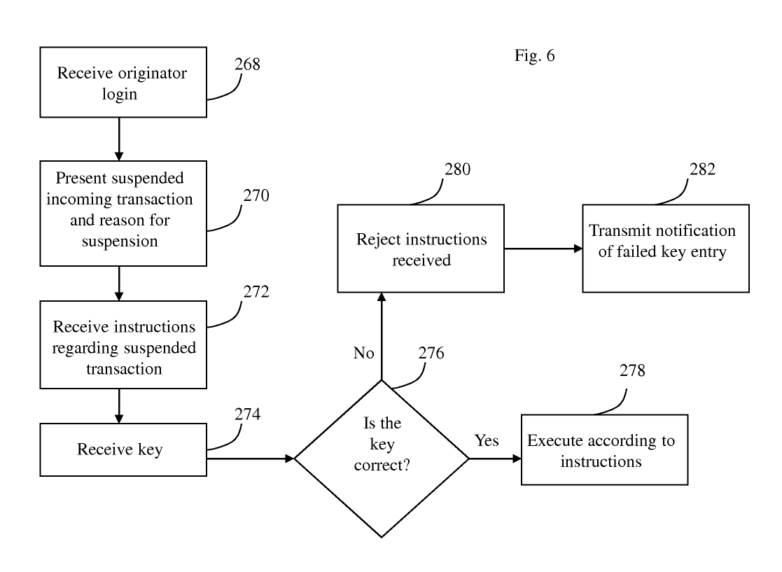

FIG. 6 illustrates an embodiment of the originator approval process which for purposes of illustration presumes that an incoming transaction has been suspended for failing to satisfy the authorization criteria in steps 260 and 264, and notification has been transmitted to the originator per step 266. The originator would access system 210 to review suspended transactions by entering its login information which is received in step 268. In step 270, the suspended incoming transaction along with the reason for its suspension may be presented to the originator. The originator may provide instructions relating to the handling of the suspended transaction which are received in step 272.

The instructions may consist of allowing the suspended transaction to proceed, rejecting the suspended transaction or hold the suspended transaction. To effectuate the instructions, the unique key or item of information transmitted to the originator in the notification step 266 can be entered and received as shown by step 274.

System 210 will analyze the key received in step 274 and if the key is correct, the instructions will be executed as shown by steps 276 and 278. Thus, if an approval of the suspended transaction was received in step 272, the suspended transaction will be released from suspension and subsequently processed by the ODFI. If a rejection of the suspended transaction was received in step 272, then the suspended transaction will be prevented and removed in step 278.

In some cases, incoming transactions for an originator are received as a batch of transactions. ACH transactions may be received as a batch of separate transactions. For example, a batch of ACH transactions may be received which include individual transactions associated with the direct deposit of weekly payroll from an originator to its employees. The batch may include one transaction which fails to satisfy the notification criteria, thus causing the entire batch to be suspended by system 210. In some cases, a fraudulent transaction has been hidden amongst a batch also containing legitimate transactions. In the case of transactions which are received as a batch, and subsequently suspended due to one or more suspect transactions within the batch, the system may be configured to receive rejections of particular transactions within the batch which will then be removed from the batch. Alternatively, the rejection may remove the entire batch or all such batches for the originator. In some embodiments, the system may be further configured to remove the rejected suspect transactions only and rebuild the batch minus the removed transactions so that the legitimate transactions may proceed.

If the correct key was received and transaction allowed, system 210 may be configured to query the originator as to whether similar transactions should be allowed in the future, the allowed transaction should be included in the database of prior transaction data, or otherwise be used for comparative purposes in the future. If the originator desires that the allowed transaction be considered in future comparisons, system 210 may be configured to send notification of the change. The notification may include a new unique key which must be received for the change to become effective. The notification may be sent via a different communication method as the prior notification regarding the suspended transaction and/or to different notification receivers.

If a hold instruction was received in step 272 and the correct key was received in step 274, the suspended transaction may remain in the system for a preset period of time. Should this preset period of time be allowed to expire, the suspended transaction may be allowed to proceed. The system may provide this as a default or the originator may configure the system so that this occurs. Similarly, the originator may configure the system to allow suspended transactions to proceed if no instructions are received within a preset period of time or to deny suspended transactions if no instructions are received within a preset period of time.

If the correct key is not received in step 274, as shown by steps 276 and 280, the instructions received in step 272 will be rejected. System 210 may allow one or more additional chances for the originator to enter the correct key, but may lock out the system and will transmit notification of the failed key entry in step 282. The notification may be sent via any of the methods described herein to any notification receiver.

In some embodiments, failure to satisfy the authorization criteria will not cause a transaction to be suspended. The suspect transaction will be processed according to normal procedure without any delay. However, notification of the failure will be sent to the originator according to the originator's notification preferences while the suspect transaction will be permitted to post to the originator's account. Thus, the account may be debited by the amount involved in the suspect transaction before the originator has acted on the notification and instructions are received. Should the system receive a rejection of the transaction by the originator subsequent to posting, which may occur using similar or the same systems and methods described herein, the system can credit the transaction amount to the originator's account. The system may then create a “return entry” or otherwise notify the ODFI of the rejection and credit for further processing or investigation by the financial institution. The transaction will be allowed to proceed if the originator does nothing. However, the originator may access the system for purposes of including the suspect transaction among the prior transaction data or otherwise making changes such that future similar transactions will not fail to satisfy the authorization criteria. This may be accomplished and require key entry as described above.

Although the system and methods described herein involve the transfer of files, data and communication, it should be understood that various portions or components of the system and methods described herein may be located in one or a plurality of different locations, while still functioning seamlessly through, for example, conventional methods of wired or wireless electronic communication. Embodiments discussed herein, or features and portions thereof, may also be provided in a computer program product, such as those which incorporate computer usable medium for various operative features and portions thereof, such as portable media and devices capable of storing computer readable data and software, downloadable data and software, pre-loaded data and software and internet-based applications, among other things.

Some embodiments may also incorporate sending advertising or promotional information relating to a variety of subjects, such as programs and benefits offered by the account holder's financial institution, which may be transmitted to account holders subscribing to the system described herein through the notification preferences set forth by each account holder in their respective preset notification criteria.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. Various features and advantages of the disclosure are set forth in the following claims.

1. A method of protecting account holders against fraudulent transactions, comprising the steps of:
receiving authorization criteria, wherein the authorization criteria relates to one or more characteristics associated with financial transactions that involve an account in a financial institution;
receiving incoming transaction data wherein the incoming transaction data is associated with an underlying financial transaction involving the account;
identifying the one or more characteristics associated with the incoming transaction relating to the authorization criteria received;
identifying prior transactions with one or more characteristics corresponding with the identified one or more characteristics associated with the incoming transaction data;
comparing the incoming transaction data with the authorization criteria;
suspending the underlying transaction associated with the incoming transaction data if the authorization criteria is not satisfied;
transmitting notification of the suspension to the account holder associated with the suspended underlying transaction data through a first communication method, wherein the transmitted notification includes a unique item of information; and
permitting the suspended underlying transaction to proceed if the unique item of information is received through a second communication method.

2. The method according to claim 1, further comprising the steps of:
providing a listing of characteristics relating to transactions to the account holder; and
receiving a selection of listed characteristics from the account holder.

3. The method according to claim 1, further comprising the steps of:
receiving the unique item of information through the second communication method;
permitting the suspended underlying transaction to proceed;
adding the characteristics associated with the suspended underlying transaction to the prior transaction data;
transmitting notification of the addition of the suspended underlying transaction to the prior transaction data, wherein the transmitted notification includes a unique item of information; and
permitting the suspended underlying transaction to be added to the prior transaction data if the unique item of information is received through a second communication method.

4. The method according to claim 1, wherein the authorization criteria further comprises the communication methods by which the account holder is to be notified.

5. The method according to claim 1, wherein the second communication method comprises an SMS message transmitted to a mobile device.

6. The method according to claim 1, further comprising the step of generating a unique item of information.

7. The method according to claim 1, further comprising the step of:
determining whether the incoming transaction data involves an account holder from which authorization criteria has been received; and
permitting the underlying transaction to proceed if the incoming transaction involves an account holder from which authorization criteria has not been received.

8. The method according to claim 1, wherein the underlying transaction is an ACH transaction in which the account holder is the originator.

9. The method according to claim 1, wherein the underlying transaction is a wire transfer.

10. A system of protecting account holders against fraudulent transactions, comprising:
(a) a data input device configured for:
(i) receiving authorization criteria, wherein the authorization criteria relates to one or more characteristics associated with financial transactions that involve an account in a financial institution;
(ii) receiving incoming transaction data wherein the incoming transaction data is associated with an underlying financial transaction involving the account;
(b) a processor configured for:
(i) identifying the one or more characteristics associated with the incoming transaction relating to the authorization criteria received;
(ii) identifying prior transactions with one or more characteristics corresponding with the identified one or more characteristics associated with the incoming transaction data;
(iii) comparing the incoming transaction data with the authorization criteria;
(iv) suspending the underlying transaction associated with the incoming transaction data if the authorization criteria is not satisfied; and
(c) a data output device configured for:
(i) transmitting notification of the suspension to the account holder associated with the suspended underlying transaction data through a first communication method, wherein the transmitted notification includes a unique item of information and the underlying transaction will be permitted to proceed if the unique item of information is received through a second communication method.

11. The system of claim 10, further comprising a database for storing the authorization criteria.

12. The system of claim 10, wherein the data output device is configured for communicating via SMS messages, MMS messages and phone calls.

13. The system of claim 10, wherein the underlying transaction is an ACH transaction.

14. The system of claim 10, further comprising a database for storing prior transaction data.
